(19) United States
(12) Patent Application Publication
(10) Pub. No.: US 2005/0030155 A1
(43) Pub. Date: Feb. 10, 2005

(54) Automatic sentry protector (ASP)

(76) Inventor: Reggie Johnson, Wilmington, DE (US)

Correspondence Address: Reggie Johnson, 5 Ingrid Court, Wilmington, DE, 19808, US

(21) Appl. No.: 10/637,093

(22) Filed: Aug. 6, 2003

(51) Int. Cl. H04Q 1/00; H04Q 9/00; G05B 23/00

(52) U.S. Cl. 340/5.61

(57) ABSTRACT

The Automatic Sentry Protector (ASP), unlocks vehicle doors as the driver approaches the automobile allowing the driver to start the car within a 30 foot radius (via 433.92 MHz Frequency Transmitter). When the driver walks away from the car, doors lock and the ignition system disconnects, which shuts the car off if the engine is running (via two channel receiver with relays). In addition, as the driver approaches his or her residence the ASP unlocks the house door and relocks the door once the inhabitant is inside (via two channel receiver and solenoid gear box). All maneuvers can be done automatically or manually with the push of a larger button or manually by depressing a smaller button on a tiny remote. The ASP receiver operates off of a 12 volt DC power supply and the Transmitter operates off of a 1.5 volt AAA battery.

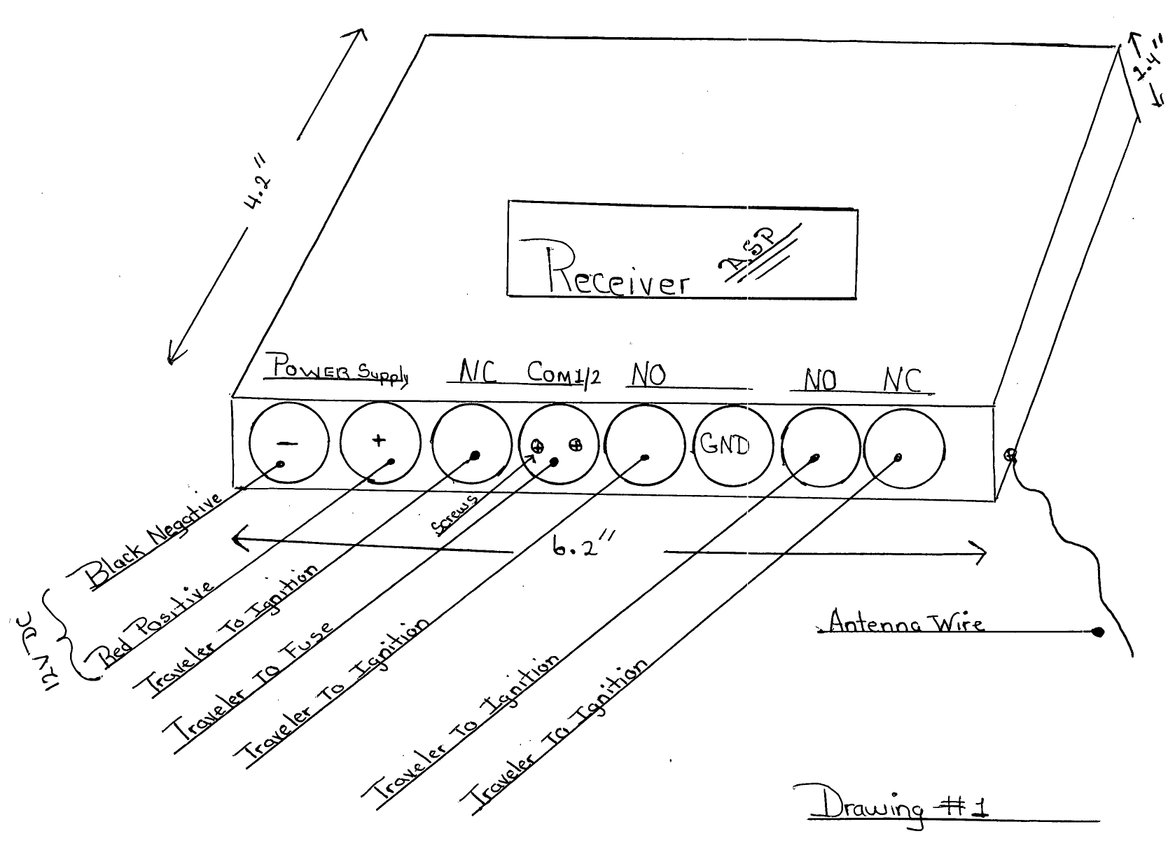

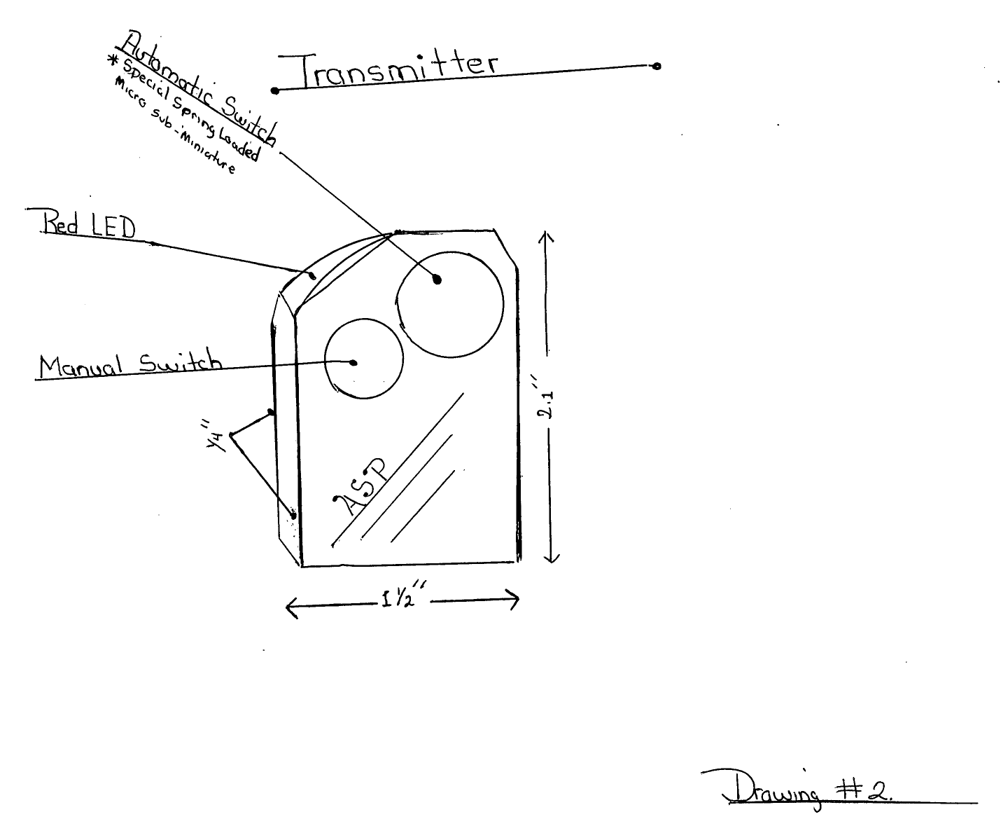

The Automatic Sentry Protector (ASP) is a complete and self contained security/quick access system that provides hands free keyless vehicular and house entry/security. The ASP is constructed of two receivers and one transmitter that operates both receivers.

### TRANSMITTER

Fixed 433.92 MHz transmitter frequency as required by law.
Standard design PC board
Two code channels.
Saw resonator.
12V DC battery terminal power supply.
Two operational push button switches (sub-miniature).
   a. SW 1 being a standard momentary device.
   b. SW 2 being a special constant on/off spring loaded device. (This is what makes the ASP unique)

### RECEIVERS

Two code channels.
Two relays.
Standard PC Board
Adjustable tuning capacitor.
Two normally open bays.
Two normally closed bays.
Two common bays.
One 12V power supply

### SOLENOID

12V coil.
Gear box. (dimensions . . . 1 inch by 2.5 inches)
Spring loaded cylinder.

### OPERATIONAL CONSTRUCTION

The ASP shall be constructed in such a unique manner as to utilize a standard 433.92 MHz Transmitter and two Receivers acceptable of like frequencies in such a manner as to create and maintain a hands free automatic security and entry system.
1. Connect 12V positive (+) lead from under dash fuse bank to positive (+) terminal on vehicular receiver hereafter referred to as THE LASSO KEY RECEIVER.
2. Connect 12V negative (−) lead from under dash fuse bank to negative (−) terminal on vehicular receiver.
3. Connect leads from the Normally Closed terminals of the Lasso Key Receiver together and then splice one side of cut ignition wire ( leading to fuse bank) to those connected leads. (Duplicate same procedure at fuse leading to automatic door locks).
4. Connect leads from Common terminals of the Lasso Key Receiver together and then splice remaining side of cut ignition wire (leading to fuse bank) to those connected leads. (Duplicate same procedure at fuse leading to automatic door locks).
5. Connect 12V Adapter to the power terminal of the second receiver hereafter referred to as THE DOORMAN.
6. Connect positive (+) and negative (−) leads from Doorman receiver to the positive (+) and negative (−) leads of the 12V Solenoid and attaching gear box.
7. Mount the Doorman receiver to the door and attach gear box to dead bolt apparatus in such manner as to have it freely turn dead bolt manually.
8. Secure and ground all receivers, accessories, and attachments etc.
9. Tune Doorman and Lasso Key receivers to operate most efficiently and effectively at 30 or less feet.

1. The ASP is the world's only totally automatic, portable, hands free device/system that both secures your home and vehicle as well as provide keyless entry via Radio Frequency. That is activated by approach and/or departure of its possessor or basically walking toward and/or away from the home or vehicle. A single device which marries the dual tasks of home and vehicular security/keyless entry to one triggering mechanism, which secures both home and vehicle irregardless if keys are accidentally or purposely left in the door cylinder or vehicle ignition or not. That performs automatically as a standard function, or manually as an overriding choice of the possessor. The ASP has one transmitter and two receivers. The receiver, application and apparatus used for home security/entry is independently called: THE DOORMAN . . . the receiver, application and apparatus used for vehicular security/entry is independently called: THE LASSO KEY.
